(19) United States
(12) Patent Application Publication
(10) Pub. No.: US 2007/0028524 A1
(43) Pub. Date: Feb. 8, 2007

(54) Sealing structure for vehicle door

(75) Inventors: Takayoshi Hiramatsu, Aichi-ken (JP); Teruyuki Okajima, Aichi-ken (JP); Masaaki Morikawa, Toyota-shi (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-ken (JP); TOYOTA JIDOSHA KABUSHIKI KAISHA, Toyota-shi (JP)

(21) Appl. No.: 11/493,901

(22) Filed: Jul. 27, 2006

(30) Foreign Application Priority Data
Aug. 5, 2005 (JP) 2005-227897

(51) Int. Cl. E06B 7/16

(52) U.S. Cl. 49/475.1

(57) ABSTRACT

A sealing structure for a vehicle door, which includes a door frame, a partition sash, a sliding door glass and a quarter member which are respectively provided in the door frame and the partition sash. The sliding door glass is sealed with a glass run, whereas the quarter member is sealed with a quarter weather strip. A corner piece is attached in a space defined with the door frame and an upper end of the partition sash. Seal lips are respectively formed on outer surfaces of corner parts of the glass run and the quarter weather strip so as to elastically contact facing surfaces of the corner piece to provide a secure seal between the door frame and the upper end of the partition sash.

### CROSS-REFERENCE TO RELATED APPLICATION

This application is related to and claims priority from Japanese patent application No. 2005-227897 incorporated herein by reference.

### BACKGROUND OF THE INVENTION

1. Field of the Invention

The present invention relates to a sealing structure for sealing a vehicle door of a motor vehicle around a connecting area between a door frame and a partition sash.

2. Description of Related Art

As shown in FIG. 1, a door frame 10 extends above a door belt line of a vehicle door. In a rear door 12, a partition sash 14 extends downwardly from a rear part of the door frame 10. A quarter door glass 16 is fixedly mounted on the rear side of the partition sash 14, and a door glass 18 is movably mounted on the front side of the partition sash 14.

A periphery of the quarter door glass 16 is sealed with a quarter weather strip 20 against the rear part of the door frame 10 and a rear face of the partition sash 14. And a periphery of the door glass 18 which is raised in its closed position is sealed with a glass run 22 attached along a front part of the door frame 10 and a front face of the partition sash 14.

As shown in FIG. 2, an end cap 24 is attached to at least an upper end of a partition sash 14A to connect the partition sash 14A to a door frame 10A. Publication of Japanese utility model application No. Hei 3-51616, ex. discloses that the above-described end cap is formed integrally with the glass run or the quarter weather strip as a packing.

As shown in FIG. 3, an upper end of a partition sash 14B, which is connected to a door frame 10B, has a cavity therein. And a front corner 28 of a quarter weather strip 20B and a rear corner 30 of a glass run 22B are disposed in this cavity of the partition sash 14B. Generally, the front corner 28 of the quarter weather strip 20B and the rear corner 30 of the glass run 22B respectively have the cross-sections similar to those of straight parts thereof, and are not provided with any seal lip. Therefore, in the connecting area between the door frame 10B and the upper end of the partition sash 14B, a space is defined between the front corner 28 of the quarter weather strip 20B and the rear corner 30 of the glass run 22B to degrade the sealing properties in this connecting area.

To overcome this problem, in one example of a conventional sealing structure, as shown in FIG. 3, a corner piece 26 is fitted in the space formed in the connecting area between the door frame 10B and the upper end of the partition sash 14B (see Japanese Patent No. 3428383, ex.).

However, there occur variations in the assembling and/or dimensions of parts such as the glass run 22B, quarter weather strip 20B, the partition sash 14B and the corner piece 26 so that gaps between these parts have not been filled with the corner piece 26 sufficiently. To overcome this problem, sheet-shaped seal members (not shown) are provided in the corner piece 26 or corners 28 and 30 of the quarter weather strip 20B and the glass run 22B to enhance the sealing properties around these gaps. However, the assembling work of the sheet-shaped seal members is troublesome, and the production costs increase.

Publication of unexamined Japanese patent application No. Hei 10-157459 ex. discloses that flat seal lips are extended from the corners of the glass run and the quarter weather strip into the cavity of the partition sash so as to overlap each other for enhancing the sealing properties in the transverse directions of the quarter weather strip and the glass run.

However, in order to overlap the flat seal lips each other, the overlapping parts thereof must be formed with accuracy, it becomes complicated to maintain the configuration of the overlapping parts, and the producing work is troublesome. Upon assembling, the overlapping parts must be fitted in the partition sash after the corners of the quarter weather strip and the glass run are overlapped with each other. Such assembling work is troublesome.

In a front door 34 (FIG. 1), similar gaps are formed between a quarter weather strip of a door mirror base 36 and a glass run 38 attached to the door frame 10 to cause problems similar to those in the case of the rear door 12.

### SUMMARY OF THE INVENTION

Accordingly, it is an object of the present invention to provide a sealing structure for a vehicle door, which is capable of securely providing a seal between a door frame and an upper end of a partition sash.

In accordance with the present invention, the sealing structure for a vehicle door is provided with a door frame extending above a door belt line, a partition sash provided to connect an upper side of the door frame and a door panel, a door glass which is raised and lowered along one side of the partition sash, and a quarter member which is secured to the other side of the partition sash. The sealing structure includes a glass run attached to the door frame and the one side of the partition sash for sealing around a periphery of the door glass, and a quarter weather strip attached to a periphery of the quarter member, the door frame and the other side of the partition sash for sealing around the periphery of the quarter member. The sealing structure further includes a corner piece attached between the upper side of the door frame and an upper end of the partition sash. The corner piece includes a head part and a leg part which extends downwardly from the head part. A seal lip obliquely projects from an outer surface of a corner part of at least one of the glass run and the quarter weather strip, which is adapted to contact the corner piece so as to flex and elastically contact the corner piece, thereby sealing around a periphery of the corner piece.

With this arrangement, the periphery of the door glass is sealed with the glass run attached to the door frame and the partition sash, whereas the periphery of the quarter member is sealed with the quarter weather strip attached to the periphery of the quarter member along with the door frame and the partition sash.

In addition, the corner piece is attached between the upper side of the door frame and the upper end of the partition sash so as to fill a space defined with the corner part of the glass run, the corner part of the quarter weather strip and the door frame. The corner piece has a configuration conforming to the above-described space. And a seal lip projects obliquely from an outer surface of the corner part of at least one of the glass run and the quarter weather strip, which is adapted to contact the corner piece so as to flex and elastically contact the corner piece. By virtue of the projecting seal lip, rainwater and noises can be prevented from intruding into a vehicle compartment via gaps around the upper end of the partition sash, thereby improving the sealing properties.

Where the seal lip is provided in the glass run, the seal lip flexes in accordance with variations in the assembling of the glass run relative to the corner piece to elastically contact the corner piece, thereby forming a seal between the corner part of the glass run and the corner piece. And where the seal lip is provided in the quarter weather strip, the seal lip flexes in accordance with variations in the assembling of the quarter weather strip relative to the corner piece to elastically contact the corner piece, thereby forming a seal between the corner part of the quarter weather strip and the corner piece.

In a preferred embodiment, the quarter member is a quarter door glass, and the quarter weather strip is a quarter weather strip that is attached to a periphery of the quarter door glass in a ring-shaped configuration. Where the quarter door glass is provided in a front door and a rear door of a motor vehicle, the quarter weather strip is attached to the periphery of the quarter door glass and is secured to the door frame, thereby sealing around the periphery of the quarter door glass.

In another preferred embodiment, the quarter member is a door mirror base, and the quarter weather strip is a quarter weather strip that is attached to a periphery of the door mirror base. Where a door mirror is provided in a front door of a motor vehicle, the quarter weather strip is attached to the periphery of the door mirror base and is secured to the door frame, thereby sealing around the periphery of the door mirror base.

In another preferred embodiment, the corner piece has one contacting surface adapted to contact the corner part of the glass run, which has a configuration conforming to the corner part of the glass run and extends downwardly from a lower surface of the head part via one side surface of the leg part. The corner piece has the other contacting surface adapted to contact the corner part of the quarter weather strip, which has a configuration conforming to the corner part of the quarter weather strip, and extends downwardly from the lower surface of the head part via the other side surface of the leg part.

With this arrangement, the corner part of the glass run can be disposed in contact with the one contacting surface of the corner piece, and the seal lip projecting obliquely from the corner part of the glass run can be brought into contact with the one contacting surface of the corner piece securely, thereby effecting good sealing properties.

In addition, the corner part of the quarter weather strip can be disposed in contact with the other contacting surface of the corner piece, and the seal lip projecting obliquely from the corner part of the quarter weather strip can be brought into contact with the other contacting surface of the corner piece securely, thereby effecting good sealing properties.

In another preferred embodiment, the seal lip projecting obliquely from the outer surface of the corner part of at least one of the glass run and the quarter weather strip is formed continuously with a seal lip which is formed on an outer surface of a straight part of at least one of the glass run and the quarter weather strip so as to obliquely project therefrom.

With this arrangement, a seal lip is continuously formed along the periphery of at least one of the glass run and the quarter weather strip over the entire length thereof without any interruption of its sealing line, thereby improving the sealing properties.

In another preferred embodiment, the glass run includes straight parts which are formed by extrusion, and are adapted to be attached to an upper side and a vertical side of the door frame as well as the partition sash, and corner parts which are formed by molding to connect the straight parts to each other, and are adapted to be attached to corner parts between the upper side of the door frame and the partition sash. The straight parts and the corner parts of the glass run respectively have a main body including an outer side wall, an inner side wall and a bottom wall with a generally U-shaped cross-section.

With this arrangement, the corner parts of the glass run, which conform to configurations of the corner parts between the door frame and the partition sash, can be formed by molding, and the straight parts of the glass run can be connected simultaneously with the molding of the corner parts. The periphery of the door glass can be slid along and sealed with the main body of the glass run attached to the door frame and the partition sash, which includes the outer side wall, the inner side wall and the bottom wall with a generally U-shaped cross-section.

In another preferred embodiment, the seal lip projecting obliquely from the corner part of at least one of the glass run and the quarter weather strip is formed so as to project outwardly from an outer surface of the bottom wall of at least one of the glass run and the quarter weather strip.

With this arrangement, the outwardly projecting seal lip flexes and elastically contacts facing surfaces of the door frame and the partition sash to ensure sealing properties between the door frame and the partition sash.

In a further preferred embodiment, the straight parts and the corner parts of the quarter weather strip are integrally formed by molding, the main body of each of the straight parts and the corner parts includes an outer side wall, an inner side wall and a bottom wall with a generally U-shaped cross-section.

With this arrangement, borders of the straight parts and the corner parts of the quarter weather strip are free from any difference in level and color so that no borderline exists therebetween, thereby exhibiting good sealing properties. The quarter Weather strip can be entirely formed by molding so as to be produced efficiently. The periphery of the quarter door glass can be held with the main body of the quarter weather strip, which includes the outer side wall, the inner side wall and the bottom wall with a generally U-shaped cross-section, whereby the quarter door glass can be fixedly secured to the door frame and the partition sash.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a side view of a motor vehicle provided with a sealing structure;

FIG. 2 is a side view of a rear corner of a rear door of a motor vehicle;

FIG. 3 is a partially cut away longitudinal-sectional view of a connecting area between a door frame and a partition sash of a rear door, which is provided with a conventional sealing structure;

FIG. 4 is a partially cut away longitudinal-sectional view of a connecting area between a door frame and a partition sash of a rear door, which is provided with one embodiment of a sealing structure in accordance with the present invention;

FIG. 5(A) is a partially cut away cross-sectional view of a connecting area between a door frame and a partition sash of a rear door, which is taken along the line M-M of FIG. 4;

FIG. 5(B) is a partially cut away cross-sectional view of a connecting area between a door frame and a partition sash of a rear door, which is taken along the line N-N of FIG. 4;

FIG. 6 is a perspective view of a corner piece which is used in one embodiment of a sealing structure in accordance with the present invention;

FIG. 7(A) is a perspective view of a corner part of a glass run, which is adapted to be attached to a connecting area between a door frame and a partition sash of a rear door, in one embodiment of a sealing structure in accordance with the present invention;

FIG. 7(B) is a partially cut away perspective view of a corner piece which is attached to an upper end of a partition sash in one embodiment of the sealing structure in accordance with the present invention; and

FIG. 7(C) is a perspective view of a corner part of a quarter weather strip, which is adapted to be attached to a connecting area between a door frame and a partition sash of a rear door, in one embodiment of a sealing structure in accordance with the present invention.

### DETAILED DESCRIPTION OF THE PREFERRED EMBODIMENTS

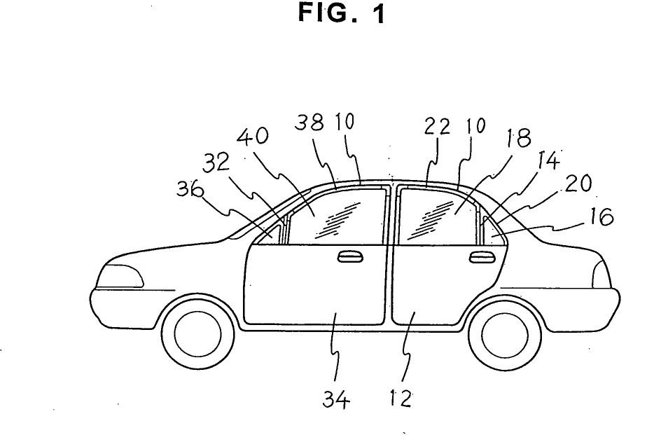

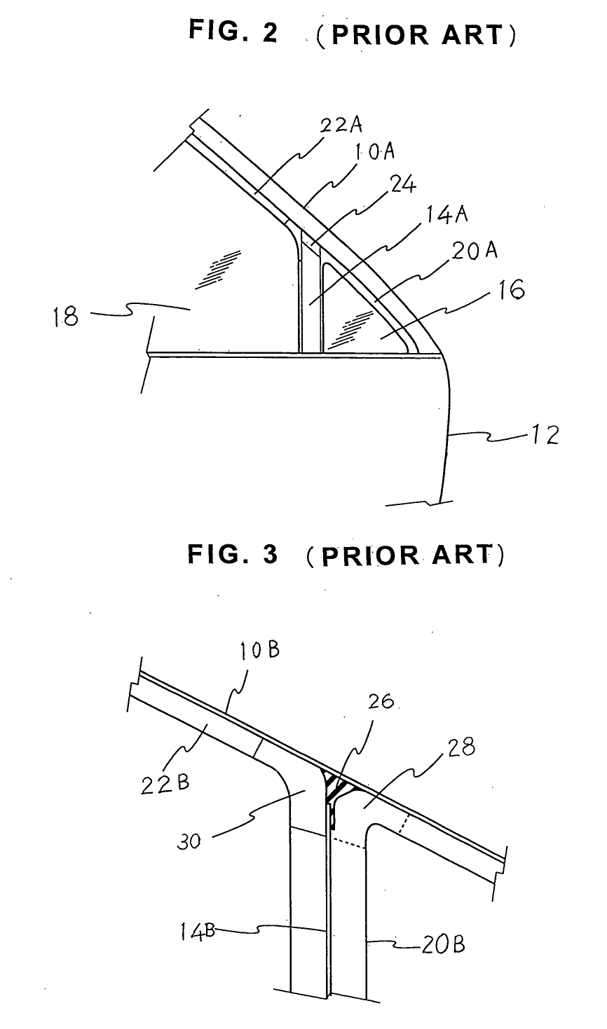

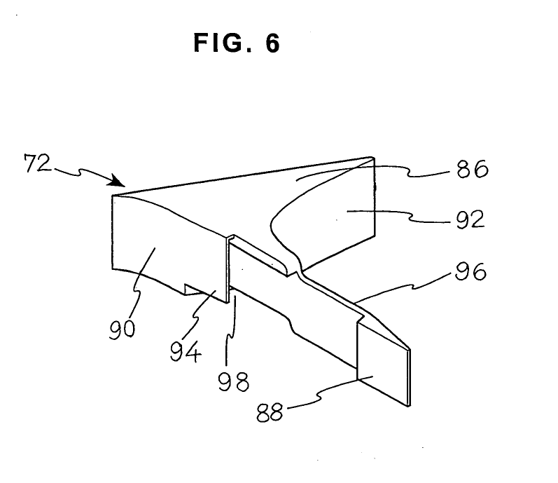

Hereinafter, one embodiment of a sealing structure for a vehicle door in accordance with the present invention will be explained with reference to FIGS. 1, 4 through 7(C). In these drawings, the sealing structure of the present invention was applied to a rear door of a motor vehicle. The sealing structure of the present invention is also applicable to a front door of the motor vehicle.

As shown in FIG. 1, in the rear door 12 of the motor vehicle, the partition sash 14 extends downwardly from a rear part of the door frame 10, and is exposed above the door belt line. A lower end of the partition sash 14 is fixed to an inside of a door panel of the rear door 12.

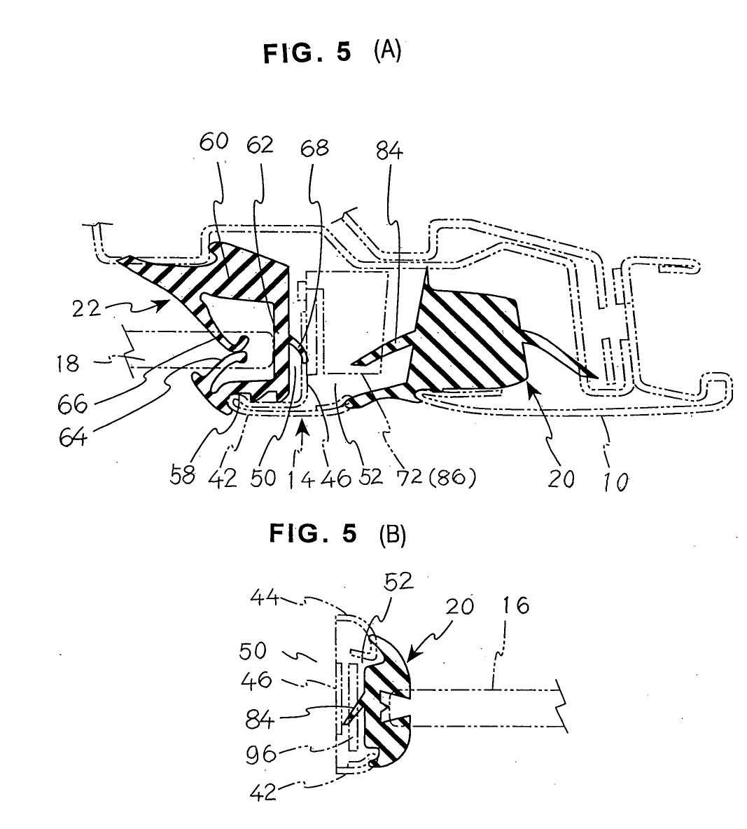

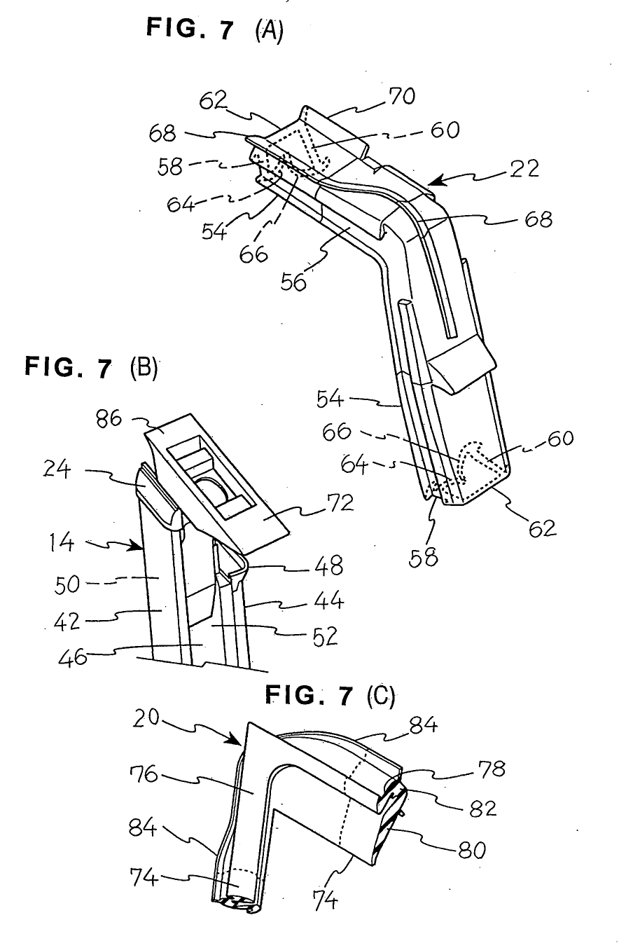

As shown in FIGS. 5(A), 5(B) and 7(B), the partition sash 14 includes an outer side wall 42, an inner side wall 44 and a connection wall 46 for connecting the outer side wall 42 and the inner side wall 44 to each other. The outer side wall 42 and the inner side wall 44 are respectively connected to lower ends of an inner side wall and an outer side wall of the door frame 10 via an end cap 48, whereas the connection wall 46 is secured to a lower surface of a bottom wall of the door frame 10 with a bracket (not shown). And the connection wall 46 defines a front channel 50 and a rear channel 52 on the front and rear sides thereof.

The glass run 22 is continuously attached to a front vertical side and an upper side of the door frame 10 as well as the front channel 50 of the partition sash 14 to guide the door glass 18 upwardly and downwardly and provide seals between the door glass 18 and the door frame 10 as well as the partition sash 14.

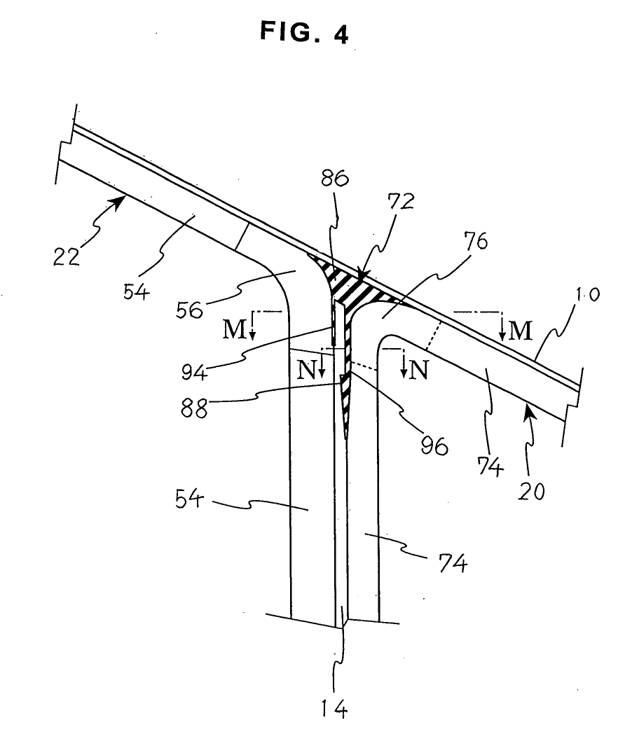

As shown in FIG. 4, the glass run 22 includes straight parts 54 which are formed generally straight by extrusion, and corner parts 56 which are formed by molding so as to connect the straight parts 54 to each other.

The straight parts 54 may be formed by injection molding.

The straight parts 54 are adapted to be attached to the front vertical side, and the upper side of the door frame 10 as well as the front channel 50 of the partition sash 14. These straight parts 54 are connected to each other by molding in conformity with a front corner and a rear corner of the door frame 10 to form the corner parts 56. Bending angles, etc. of the corner parts 56 are determined to correspond to those of the front corner and the rear corner of the door frame 10.

A rear corner of the glass run 22, which is adapted to be attached to the rear corner between the upper side of the door frame 10 and the front side of the partition sash 14 is shown in FIG. 7(A).

The cross-sectional shape of the corner part 56 is substantially equal to that of the straight part 54. And a main body thereof includes an outer side wall 58, an inner side wall 60 and a bottom wall 62 and has a generally U-shaped cross-section.

An outer seal lip 64 and an inner seal lip 66 respectively project from open ends of the outer side wall 58 and the inner side wall 60 towards an interior of the main body with a U-shaped cross-section to seal both surfaces of the door glass 18.

The straight part 54 adapted to be attached to the upper side of the door frame 10 is continuously connected to that adapted to be attached to the front side of the partition sash 14 by gradually varying the cross-sectional shape of the corner part 56.

A first seal lip 68 projects obliquely outwardly from an outer edge of the bottom wall 62, whereas a second seal lip 70 projects obliquely inwardly from an inner edge of the bottom wall 62. The second seal lip 70 is formed in only the straight part 54, whereas the first seal lip 68 extends continuously along the straight part 54 and the corner part 56. In the corner part 56, the first seal lip 68 curves inwardly and continuously extends in about a widthwise center thereof.

When the glass run 22 is attached to the partition sash 14, the first seal lip 68 thus arranged seals the outer surface of the glass run 22 against the door frame 10 and the partition sash 14 inclusive of the connecting area between the door frame 10 and the partition sash 14.

Since the first seal lip 68 obliquely extends outwardly from the outer edge of the bottom wall 62, it can securely prevent water from intruding into a vehicle compartment from the outside of the motor vehicle. In addition, since the first seal lip 68 can flex, it can securely contact a facing surface of a later describing corner piece 72.

As shown in FIG. 1, the quarter weather strip 20 is attached along the rear part of the door frame 10 and the rear channel 52 (FIG. 7(B)) of the partition sash 14 to secure the quarter door glass 16 to the rear door 12 and seal the periphery of the quarter door glass 16 against the door frame 10 and the partition sash 14.

As shown in FIG. 7(C), the quarter weather strip 20 is generally formed by molding such that straight parts 74 are integral with a corner part 76. Alternatively, the straight parts 74 may be formed by extrusion, whereas the corner part 76 is formed by molding.

The straight parts 74 are adapted to be attached to the door frame 10 as well as the rear channel 52 of the partition sash 14. The bending angle, etc. of the corner part 76 are determined to correspond to those of the corner between the upper side of the door frame 10 and the partition sash 14.

The quarter weather strip 20 includes an outer side wall 78, an inner side wall 80 and a bottom wall 82 and has a generally U-shaped cross-section.

A seal lip 84 projects obliquely outwardly from the bottom wall 82. The seal lip 84 extends continuously along the straight parts 74 and the corner part 76, and elastically contacts the door frame 10 and the partition sash 14 as well as the corner piece 72, thereby sealing around the periphery of the quarter door glass 16.

As shown in FIG. 1, a front door 34 is provided with a mirror base 36 in a front part defined with the door frame 10 and a partition sash 32 for mounting a door mirror (not shown) thereon. The mirror base 36 can be attached similarly to the quarter door glass 16 by attaching a quarter weather strip to a periphery of the mirror base 36. A quarter door glass may be attached to the front door 34 in place of the mirror base 36, similarly to the rear door 12.

In the rear door 12, ex. of the vehicle body, the corner part 56 of the glass run 22 is disposed in a front corner between the upper side of the door frame 10 and the upper end of the partition sash 14, whereas the corner part 76 of the quarter weather strip 20 is disposed in a rear corner between the upper side of the door frame 10 and the upper end of the partition sash 14. These corner parts 56 and 76 have both round contours, and as described above, the upper end of the partition sash 14 has a cavity therein so that a space is defined with the upper side of the door frame 10 and the upper end of the partition sash 14 between the corner parts 56 and 76 of the glass run 22 and the quarter weather strip 20. As shown in FIG. 4, the corner piece 72 is provided to fill this space.

The corner piece 72 will be explained with reference to FIGS. 4, 6 and 7(B).

As shown, the corner piece 72 has a generally T-shaped configuration, and includes a head 86 and a leg 88 which integrally extends from the head 86.

The head 86 of the corner piece 72 has a flat upper surface for contacting a lower surface of the door frame 10, and a recess is formed in the flat upper surface of the head 86. An L-shaped bracket (not shown) extending from the leg 88 is attached in this recess for attaching the upper end of the partition sash 14 to the door frame 10.

The head 86 has a curved front side surface 90 which extends from a front edge of the flat upper surface toward the leg 88. When the glass run 22 is attached to the front channel 50 of the partition sash 14, the first seal lip 68 extending along the corner part 56 flexes to elastically contact the curved front side surface 90 of the head 86 of the corner piece 72.

Consequently, the first seal lip 68 seals the outer surface of the glass run 22 against the door frame 10 and the partition sash 14 as well as the corner piece 72 provided in the connecting area between the door frame 10 and the partition sash 14.

Conventionally, there are the cases where a coalking sponge is bonded to the corner part of the glass run to ensure the sealing properties between the glass run and the door frame. However, as described above, the upper end of the partition sash has a cavity therein so that the coalking sponge thus bonded has not effectively achieved good sealing properties. In contrast, with the present invention, the corner piece 72 is provided, and the first seal lip 68 is formed in the outer surface of the glass run 22 such that a projecting end thereof elastically contacts the curved front side surface 90 of the corner piece 72, thereby achieving good sealing properties. As a result, the bonding work of the coalking sponge can be omitted to facilitate the production of the glass run and reduce the production costs thereof.

The head 86 also has a curved rear side surface 92 which extends from a rear edge of the flat upper surface toward the leg 88 so as to face the corner part 76 of the quarter weather strip 20.

When the quarter weather strip 20 is attached to the rear channel 52 of the partition sash 14, the seal lip 84 extending along the corner part 76 flexes to elastically contact the curved rear side surface 92 of the head 86.

Since the seal lip 84 obliquely projects outwardly from the outer edge of the bottom wall 82, it elastically contacts the curved rear side surface 92 of the corner piece 72 in a linear sealing line to enhance the sealing properties. In addition, since the seal lip 84 can flex, it can exhibit good sealing properties against the corner piece 72 irrespective of variations in the assembling of the door frame 10 and/or the partition sash 14.

The corner piece 72 is further provided with a front leg 94 which extends downwardly from the front side surface 90 integrally therewith. A rear side surface of the leg 88, which extends downwardly from the rear side surface 92 continuously therewith, serves as a rear leg 96.

The front leg 94 and the rear leg 96 define a recess 98 therebetween. Upon attaching the partition sash 14 to the door frame 10, the upper end of the partition sash 14 is inserted and fitted in the recess 98 of the corner piece 72, and then the corner piece 72 is attached to the bottom surface of the door frame 10 using the bracket.

Next, the method for producing the quarter weather strip 20 and the glass run 22 will be explained. At first, straight parts 54 of the glass run 22 are formed by extrusion, and the corner parts 56 are formed by molding.

The straight parts 54 of the glass run 22 are composed of synthetic rubber, thermoplastic elastomer, or soft synthetic resin. Examples of the synthetic rubber include EPDM rubber, examples of the thermoplastic elastomer include olefin-based elastomer, and examples of the soft synthetic resin include soft vinyl chloride. In the case of the synthetic rubber, after extruded, an extruded body is transferred into a vulcanizing room, and is heated with hot wind, high frequency wave, etc. for vulcanization. In the case of the thermoplastic elastomer and the soft synthetic resin, the extruded body is cooled for solidification. And then, the obtained body is cut into a predetermined length.

Next, the corner part 56 is formed by placing ends of the extruded bodies which have been cut into predetermined lengths in a mold, and injecting a solid material adapted to compose the molded parts into a cavity of the mold. The cross-sectional shape of the resultant molded part is approximately equal to that of the extruded part. The first seal lip 68 is continuously formed in both the extruded part and the molded part. It is preferable to use the material of the same kind as that of the material used upon extrusion. In the case of the thermoplastic elastomer and the soft synthetic resin, the material is melted when injected into the mold so that the molded part is integrally welded to the extruded parts due to heat and pressure of the injected material.

Where the straight parts 54 of the glass run 22 are composed of EPDM rubber or thermoplastic olefin elastomer, it is preferable that the corner part 56 of the glass run 22 is composed of the thermoplastic olefin elastomer. In this case, the extruded parts and the molded part are composed of the same kind of material so as to exhibit good adhesion between the straight parts and the corner part of the glass run. In addition, these materials are all olefin-based materials, exhibit good weather resistance, can be pulverized simultaneously, and can be readily recycled. In the case of thermoplastic olefin elastomer, vulcanization is not needed so that the production is facilitated.

In the case of synthetic rubber, after injected into a mold, the mold is heated for vulcanization. The extruded parts and the molded part are composed of the same kind of material so that they can be joined to each other with vulcanization, and consequently become an integral body.

The quarter weather strip 20 may be formed similarly to the glass run 22 by forming the straight parts 74 by extrusion, and forming the corner part 76 by molding. Alternatively, the quarter weather strip 20 can be formed integrally by molding, because the dimensions thereof are small.

Where the quarter weather strip 20 is formed integrally by molding, there does not occur any difference in level between the straight parts 74 and the corner part 76, excellent sealing properties can be exhibited, and the quarter weather strip 20 can be formed by only molding, whereby the production efficiency can be enhanced.

As described above, with the sealing structure of the present invention, a corner piece is disposed and secured in a space defined with corner parts of a glass run and a quarter weather strip, and a bottom surface of a door frame, and a seal lip provided in an outer surface of the corner part of at least one of the glass run and the quarter weather strip, which are adapted to contact the corner piece, elastically contact the corner piece, thereby securely sealing the corner part of the glass run and/or the quarter weather strip against the corner piece.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A sealing structure for a vehicle door which is provided with a door frame extending above a door belt line, a partition sash extending to connect an upper side of the door frame and a door panel, a movable door glass which is raised and lowered along one side of the partition sash, and a quarter member which is secured to the other side of the partition sash, comprising:
a glass run attached to the door frame and the one side of the partition sash to provide a seal along a periphery of the door glass;
a quarter weather strip attached to a periphery of the quarter member, the door frame and the other side of the partition sash to provide a seal along a periphery of the quarter member; and
a corner piece attached between the upper side of the door frame and an upper end of the partition sash, said corner piece including a head part and a leg part which extends downwardly from said head part, a seal lip being formed on an outer surface of a corner part of at least one of the glass run and the quarter weather strip, which is adapted to contact said corner piece, so as to project obliquely from said outer surface, and said seal lip flexing and elastically contacting said corner piece to seal a periphery of said corner piece.

2. A sealing structure as claimed in claim 1, wherein said quarter member is a quarter door glass, and said quarter weather strip is a quarter weather strip attached around a periphery of said quarter door glass.

3. A sealing structure as claimed in claim 1, wherein said quarter member is a door mirror base, and said quarter weather strip is a quarter weather strip attached around a periphery of said door mirror base.

4. A sealing structure as claimed in claim 1, wherein said corner piece has one side surface adapted to contact said corner part of said glass run, which ranges from a lower surface of said head part to one side surface of said leg part, said one side surface having a configuration that conforms to said corner part of said glass run, and said corner piece has the other side surface adapted to contact said corner part of said quarter weather strip, which ranges from a lower surface of said head part to the other side surface of said leg part, said the other side surface having a configuration that conforms to said corner part of said quarter weather strip.

5. A sealing structure as claimed in claim 1, wherein said seal lip formed on said outer surface of said corner part of at least one of said glass run and said quarter weather strip is continuous with a seal lip which is formed on an outer surface of a straight part of at least one of said glass run and said quarter weather strip so as to obliquely project therefrom.

6. A sealing structure as claimed in claim 1, wherein said glass run includes straight parts which are formed by extrusion, and are adapted to be attached to an upper side and a vertical side of the door frame and the partition sash, and corner parts which are formed by molding to connect said straight parts to each other, and are adapted to be attached to corner parts between the door frame and the partition sash, and said straight parts and said corner parts of said glass run respectively have a main body including an outer side wall, an inner side wall and a bottom wall with a generally U-shaped cross-section.

7. A sealing structure as claimed in claim 1, wherein said seal lip projects outwardly from an outer surface of a bottom wall of at least one of said glass run and said quarter weather strip.

8. A sealing structure as claimed in claim 1, wherein said quarter weather strip includes straight parts and corner parts, and said straight parts and said corner parts of said quarter weather strip are integrally formed by molding, and have a main body including an outer side wall, an inner side wall and a bottom wall with a generally U-shaped cross-section.
